(19) United States
(12) Patent Application Publication
(10) Pub. No.: US 2008/0304481 A1
(43) Pub. Date: Dec. 11, 2008

(54) System and Method of Offloading Protocol Functions

(76) Inventors: Paul Thomas Gurney, Vancouver (CA); Mohammad Darwish, Vancouver (CA); Mohsen Nahvi, Vancouver (CA); May Huang Hui, Vancouver (CA); Wesam Darwish, Vancouver (CA)

Correspondence Address: FASKEN MARTINEAU DUMOULIN, LLP, 2900 - 550 Burrard Street, VANCOUVER, BC, V6C 0A3, CA

(21) Appl. No.: 11/995,483

(22) PCT Filed: Jul. 12, 2006
(86) PCT No.: PCT/CA06/01129

§ 371 Date: Aug. 12, 2008

Related U.S. Application Data
(60) Provisional application No. 60/697,981, filed on Jul. 12, 2005.

(51) Int. Cl. H04L 12/56

(52) U.S. Cl. 370/389

(57) ABSTRACT

A method of communicating a packet sent from a sending processing element to a recipient processing element over a fast Ethernet network is provided, wherein an offload engine is used to process portions of the Ethernet protocol functions. The offload engine is a field-programmable gate array in communication with a switched fabric, and can send “fake” acknowledgements of a received packet to the sending processing element. If acknowledgement of receipt of the packet is not received by the offload engine prior to expiry of a timer, the offload engine will request the sending processing element resend the packet.

This application claims the benefit of U.S. provisional patent application No. 60/697,981, filed Jul. 12, 2005, which is hereby incorporated by reference.

### FIELD OF THE INVENTION

This invention is in the field of networked communication systems and methods and more particularly to systems and methods of offloading protocol functions.

### BACKGROUND OF THE INVENTION

Ethernet networks are widely used within local area networks (LAN) to allow computers and other processing elements within to communicate. Such Ethernet networks have evolved from data traffic speeds of 1 Gigabit/second (Gbps) to 10 Gbps and greater. This increase in data traffic speeds has created a need to process the incoming and outgoing packets in a faster manner using Ethernet protocols. One such solution is the offloading of protocol functions to other parts of the system to alleviate the data traffic load at a particular point in the system.

This need for offloading protocol functions becomes both more important and more difficult as the data traffic speed increases. This is especially true for high performance embedded systems, which typically rely on high density, distributed processing elements, which are optimized to perform specific digital signal processing (DSP) functions. If such processing elements must also handle complex communication protocols such as Transmission Control Protocol/Internet Protocol (TCP/IP), commonly used in Ethernet networks, they will be able to perform far less of the signal processing function for which they were designed.

Offload engines, which are capable of handling some or the entire communication protocol stack, may be used at an Ethernet network interface. The architecture of a typical prior art high performance offload engine for a 1 Gb/s Ethernet interface is shown in FIG. 1.

Offload engine 10 provides the physical layer interface 35 to the network (through media access control (MAC) layer 40), and can move Ethernet frames between buffer memory 15 and the network. Buffer memory 15 is also accessible to a host through Peripheral Component Interconnect (PCI) bus interface 20 through memory controller 30. Software application (SA) 25 which runs on processors within offload engine 10 also accesses buffer memory 15 and can perform protocol offloading tasks. At data traffic rates of 1 Gbps, it is possible for offload engine 10 to conduct TCP offloading (e.g. segmentation and checksum operations) and even provide advanced capabilities such as iWARP and Remote Direct Memory Access (RDMA) protocol acceleration within software application 25. As future protocols become commonly used, software application 25 can be rewritten or adapted to support them.

A problem with offload engine 10 is that, for data traffic rates of around 10 Gbps or more, the architecture does not scale well. An increase in the number of processors within offload engine 10 by a factor of ten (e.g. between two to twenty) would result not only in die size and power consumption issues, but also difficulty in creating software to coordinate the processors. A ten-tupling of processor clock speeds is currently unavailable at reasonable prices, and therefore a new architecture is needed to provide similar functionality at data traffic speeds of 10 Gbps.

Another problem with a typical offload engine 10 is that at a 10 Gbps data traffic rate, offload engine 10 assumes communications occur with a single host over a PCI bus.

### SUMMARY OF THE INVENTION

A solution to the aforementioned problems is to use field-programmable gate arrays (FPGA) technology to provide a hardware application (HA) to support multiple custom protocols at very high data rates. Instead of writing software to run on a processor, the architecture runs in the configurable area of an FPGA offload engine to perform protocol offloading while using fixed function logic blocks to perform physical and logical layer interface functions.

In an embedded system, alternatively, the packets arriving to an Ethernet connection at 10 Gbps will be distributed to multiple processing elements over a switched fabric, using a RapidIO™, PCI Express™, or HyperTransport™ architecture. Bridging between a reliable, ordered switched fabric like RapidIO™ and an unreliable, unordered network like Ethernet is a difficult problem. Several strategies for connecting an Ethernet network to a RapidIO™ switched fabric are disclosed herein.

The techniques herein described for a 10 Gbps data rate can also be used for other data rates, both faster and slower (e.g. 1 Gbps Ethernet).

A method of communicating a packet sent from a first processing element to a second processing element over a network is provided, comprising the steps of: a first processing element communicating a packet addressed to a second processing element; said communicated packet, after leaving said first processing element, received by a switch fabric; said communicated packet communicated from said switch fabric to an offload engine, said offload engine comprising a hardware application; and said offload engine acknowledging receipt of said communicated packet to said first processing element, and communicating said communicated packet to said processing element. The offload engine may further comprise a timer, and the offload engine may set said timer; if the offload engine fails to receive acknowledgement from said second processing element of receipt of said communicated packet prior to expiry of said timer, the offload engine requests said first processing element to resend said packet.

The offload engine may alter the packet so that said acknowledgement of receipt of said packet from said second processor will be addressed to said offload engine. The offload engine may include a NIC to receive and communicate the packet. The offload engine may also include a state table to store the status of communications with the first processing element. The state table may be used to translate IP addresses, including a TCP port or MAC address to a RapidIO™ Device ID. The offload engine may be a field-programmable gate array. The switched fabric may be RapidIO™ switched fabric.

The network may be an Ethernet network. The Ethernet network may have a data traffic speed of at least 10 Gbps. Alternatively, the packet may be communicated from said first processing element via an ordered network and may be received by said second processing element via an unordered network, or vice versa.

A method of acknowledging receipt of a packet sent from a first processing element to a second processing element may be provided, comprising the steps of an offload engine comprising a hardware application, a state table and a timer, receiving said packet before said packet reaches said second processing element; the offload engine modifying said packet so that acknowledgement of receipt of said packet will be sent from said second processing element to said offload engine; acknowledging receipt of said packet to said first processing element; the offload engine sending said packet to said second processing element, and starting a timer when said packet is sent to said second processing element; and, the offload engine, if not having received an acknowledgement from said second processing element that said packet has been received, requesting said first processing element resend said packet. The offload engine may be a field-programmable gate array and may be in communication with a switched fabric.

A field programmable gate array for communicating packets from a first processing element to a second processing element is provided, comprising: a hardware application; means for communication with a switched fabric; means for communication with an Ethernet network; a timer; and a state table. The field-programmable gate array may include means for providing acknowledgement to a first processing element of a packet received from said first processing element and addressed to a second processing element. The field programmable gate array may further include means for receiving acknowledgement of said packet from said second processing element. The field programmable gate array of claim may also include means for timing the time taken for said acknowledgement from said second processing element to be received.

### BRIEF DESCRIPTION OF THE DRAWINGS

FIG. 1 is a block diagram showing the architecture of a typical prior art offload engine used in a 1 Gbps Ethernet network;

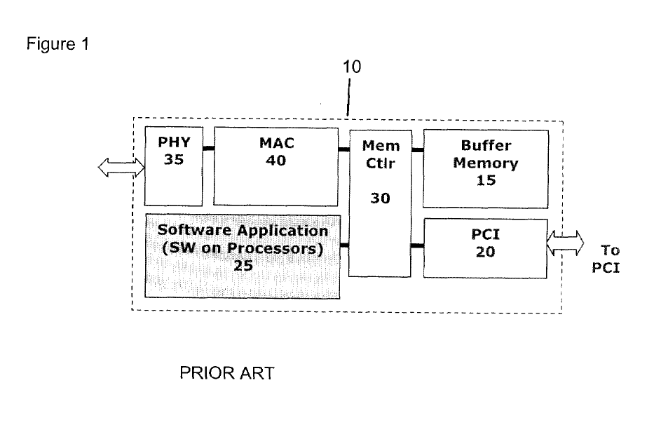

FIG. 2 is a block diagram showing a preferred embodiment of the architecture of an offload engine for a 10 Gbps Ethernet network according to the invention;

FIG. 3 is a block diagram showing the content of the hardware application therein;

FIG. 4 is a block diagram showing a system according to the invention wherein the offload engine acts as a gateway between a RapidIO™ switched fabric and 10 Gbps Ethernet network;

FIG. 5 is a block diagram showing a system according to the invention with an offload engine encapsulating RapidIO™ packets into UDP packets;

FIG. 6 is a block diagram showing an embedded system wherein the offload engine acts as a TCP termination engine; and

FIG. 7 is a flow chart showing the TCP state chart of an HTTP server application, according to the invention.

### DETAILED DESCRIPTION

### Definitions

In this document, the following terms will have the following meanings:

“embedded system” means a combination of computer hardware and software designed to perform a dedicated function.

“offload engine” means a processing element for moving one or more elements of Ethernet processing to a separate dedicated subsystem from the main processing element, for improving overall Ethernet system performance.

“ordered network” means a network wherein packets being communicated are guaranteed to arrive ordered sequentially.

“processing element” means a device having a processor, memory, and input/output means for communicating with other processing elements or users.

“switched fabric” means an architecture that allows processing elements to communicate over a switched network of connections. A switched fabric is capable of handling multiple concurrent communication channels.

“unordered network” means a network wherein packets being communicated are not guaranteed to arrive ordered sequentially.

### Hardware Application Development Environment

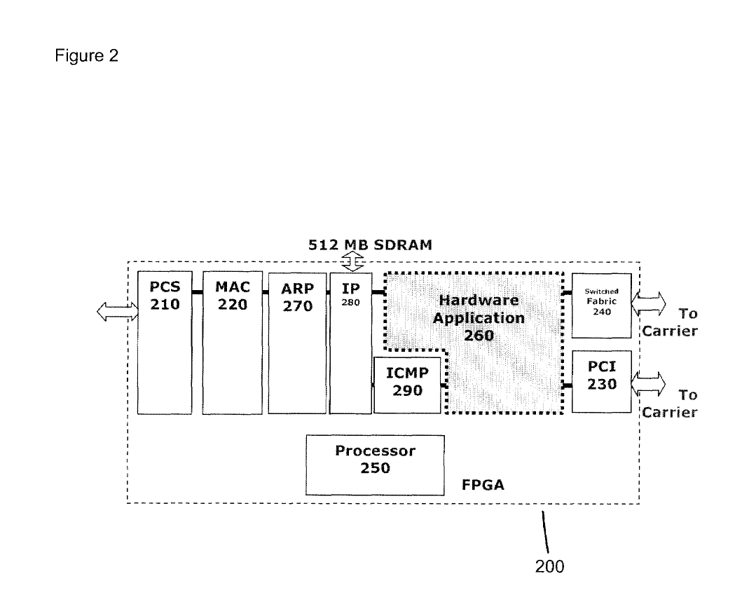

As shown in FIG. 2, the FPGA offload engine 200 (having at least two processors) on the configurable 10 Gbps network adapter implements the physical coding sublayer (PCS) 210 and media access controller (MAC) 220 to the 10 Gbps Ethernet network as well as the physical and logical layer interfaces to PCI 230 and a switched fabric 240, such as RapidIO™, PCI Express™, HyperTransport™, or XAUI interface. PCI interface 230 and RapidIO™ interface 240 are standard interfaces available as optimized logic cores from a variety of suppliers. In a preferred embodiment offload engine 200 is a multi-processor embedded system. FPGA 200 maps, places and routs these interfaces). FPGA 200 is reprogrammable, each time a new design is used, the timing of the circuit that implements the new functionality may change, FPGA 200 meets timing requirements, thereby alleviating users from concerns about the appropriate portion of the design meeting the interface timing or operating clock frequency, and thereby reducing the engineering effort when generating new custom logic. All the interfaces are controllable from processor 250, such as a PowerPC™ 405 processor, which simplifies low-data-rate testing and prototyping of hardware application 260.

There are also three optional logic blocks available which implement a full-speed ten Gbps IP endpoint within FPGA offload engine 200. These blocks are:

Address Resolution Protocol (ARP) 270: This block takes incoming IP frames and converts them into Ethernet frames by appending the Ethernet Destination and Source MAC addresses. ARP block 270 implements a Network Address to Hardware Address request and response protocol and maintains a 32-entry ARP table in hardware.

IP 280: This block terminates IP, and implements IP fragmentation and defragmentation by buffering fragmented datagrams in memory, such as synchronous dynamic random access memory (SDRAM), until the complete datagram has been received. IP block 280 checks and generated the IP checksums and also performs IP routing, supporting up to eight gateways. The IP routing tables are configured by processor 250.

Internet Control Message Protocol (ICMP) 290: ICMP block 290 implements the required ICMP protocol, for example by responding to ping/traceroute commands, and reports/counts errors.

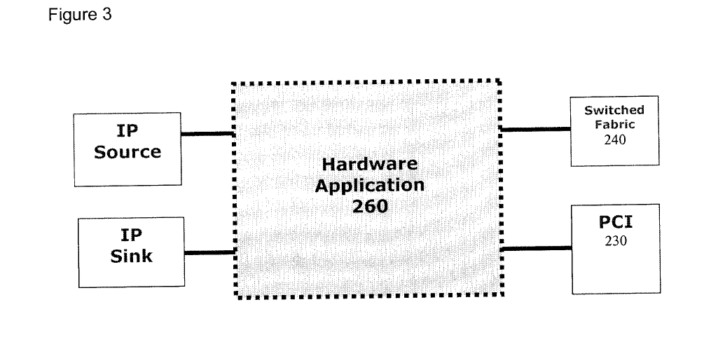

ARP block 270, IP block 280 and ICMP block 290 allow hardware application 260 to have the interfaces shown in FIG. 3.

Hardware application 260 implements a currently used or new algorithm to process data packets, for example a fast Fourier transform (FFT), or a packet filter. Hardware application 260 has full speed access to both PCI bus 230 and switched fabric 240 and can send and receive full IP datagrams to and from the 10 Gbps IP network using IP block 280 as an IP sink (packet destination) or IP source (packet source).

Using this architecture, hardware application 260 can implement any level of protocol processing from the simple to the very complicated.

### EXAMPLES OF HARDWARE APPLICATIONS

The architecture described above can be used in many ways to provide multiple processing elements on a switched fabric access to a 10 Gbps IP network.

### Example 1

### Rapid IO Gateway

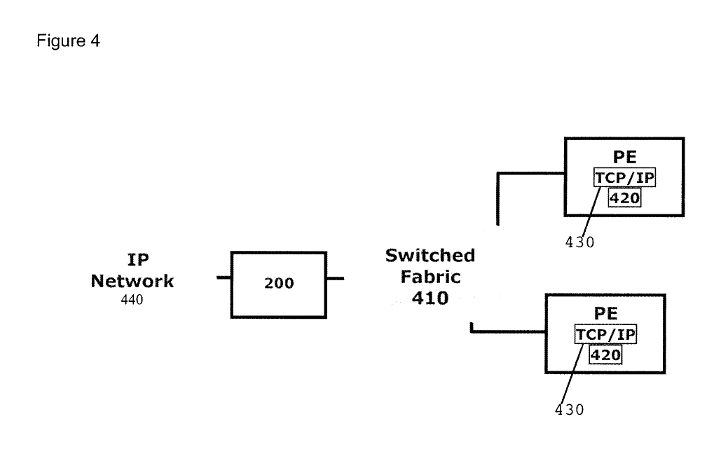

FIG. 4 shows a typical embedded system configuration with two processing elements all connected through a switched fabric to the offload engine 200 to communicate with IP network 440.

In this example, each of the processing elements 420 runs its own TCP/IP stack 430 and has its own IP address. The TCP/IP packets are wrapped up into the switched fabric's (in this example RapidIO™ 410) packets. This is effectively an IP network running over a RapidIO™ switched fabric.

Hardware application 260 acts as a gateway between the 10 Gbps IP network 440 and the RapidIO™ switched fabric network. Packets coming in from RapidIO™ 410 have their headers stripped off and the encapsulated IP packet is sent out to the IP sink. IP packets coming in from the IP source are checked against a lookup table which matches destination IP address ranges to RapidIO™ device IDs. The lookup table may be in hardware (for example in FPGA 200) or in software (for example running on processor 405). The lookup table translates or maps an Ethernet IP address and/or TCP/UDP port number and/or MAC address to a RapidIO™ Device ID and vice versa. If a match is found, the IP packet is encapsulated into a RapidIO™ packet which is sent to the appropriate RapidIO™ device ID. Hardware application 260 also implements the ARP 270 and ICMP 290 protocols on the RapidIO™ side to function as a full IP endpoint on the TCP/IP over RapidIO™ network.

This configuration allows each of the processing elements 420 attached to the RapidIO™ switched fabric 410 to have access to the 10 Gbps IP network 440.

### Example 2

### RapidIO™ Tunneling

In this example, RapidIO™ packets are encapsulated into UDP packets. Hardware application 260 tracks lost and out-of-order packets and reports these errors to processing elements 420. These errors are treated as catastrophic and may require complete system restarts.

Offload engine 200 maps ranges of RapidIO™ device IDs to IP addresses using a table set up at system startup. This system allows for interclass communication over an IP network 440 and is completely transparent to the processing elements 420. All legal RapidIO™ packets can be transferred over the network.

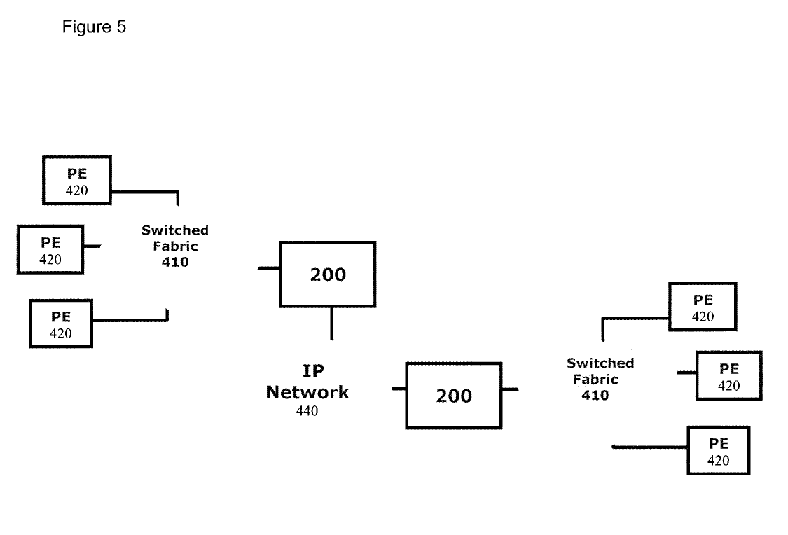

FIG. 5 shows an example RapidIO™ Tunneling system configuration.

### Example 3

### TCP Termination

In this scheme, the preferred embodiment of the invention, TCP end-points for each processing element (PE) 420 are implemented in hardware application 260 on offload engine 200. Hardware application 260 maintains the state for each TCP connection and takes care of opening and closing sockets, transferring and acknowledging data, recovering from lost packets, calculating and checking checksums, handling flow control and implementing congestion control algorithms.

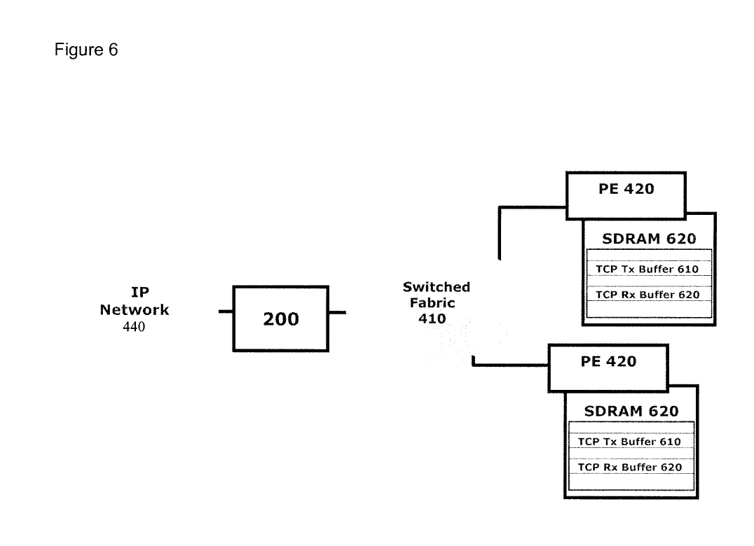

FIG. 6 shows an embedded system configuration in which several processing elements 420 are attached to a RapidIO™ switched fabric 410. Each processing element 420 has data buffers 610, 620 in RAM 620 available for each TCP connection accessible using the RapidIO™ READ and WRITE operations. PEs 420 and offload engine 200 can communicate using RapidIO™ messages in order to maintain the state of buffers 610, 620.

Each PE 420 can set up a TCP connection by sending RapidIO™ message packets to the offload engine 200. PE 420 advertises a circular Tx buffer 610 and Rx buffer 620 in its local memory for each connection in order to hold the incoming and outgoing TCP bytestreams. Offload engine 200 then implements the TCP connection end-point and reads and writes data directly from and to the PE 420's local memory when needed using the RapidIO™ IO READ and IO WRITE operations.

For example, if a transmitted TCP segment needs to be resent (due to a missing acknowledgement, for example), offload engine 200 can reread the segment and send it again. Storing the data in the PE 420's local memory dramatically reduces the memory required to be directly attached to offload engine 200. Once the segment has been successfully acknowledged, offload engine 200 informs PE 420, and that area in memory can be reused.

Using offload engine 200 to send “fake” acknowledgements, i.e. acknowledgements for packets not actually received by the destination processing element 420, improves performance of the Ethernet network. As most packets arrive at the destination processing element 420, there is no need for offload engine 200 to wait for acknowledgements from the destination processing element. By sending the “fake” acknowledgement from offload server 200, the sending processing element moves on to its next task while offload engine 200 begins a timer waiting for the real acknowledgement from the destination processing element. If such timer times out then offload engine 200 requests the data again from the sending processing element.

### Opening and Closing Connections

In a preferred embodiment of the invention, PE 420 opens a connection by sending an “Open Connection” message to offload engine 200. This message includes the following information:

Open TCP Connection (sent from PE 420 to offload engine 200)

| | |
|---|---|
| Local Connection ID | A local socket identifier |
| Passive/Active | This field indicates whether the connection open is to be |
| | passive or active. |
| Local IP Address | The IP address associated with the PE's socket. |
| Local Port Number | The port associated with the PE's socket |
| Foreign IP Address | The IP address associated with the destination socket (only |
| | valid for active opens) |
| Foreign Port Address | The port associated with the destination socket (only valid for |
| | active opens) |
| Rx Buffer Address | The starting address of the Rx Buffer |
| Rx Buffer Size | The size of the Rx Buffer (must be a power of 2) |
| Rx New Data Available | Indicates how often Rx New Data Available messages should |
| Request | be sent for this connection by the offload engine. The message |
| | can be sent once Y bytes have been successfully received since |
| | the last message. A timeout can also be used to ensure that |
| | successfully received bytes sit waiting without a status message |
| | for at most X ms. A value of 0 means never. |
| Tx Buffer Address | The starting address of the Tx Buffer |
| Tx Buffer Size | The size of the Tx Buffer (must be a power of 2). |
| Tx New Space Available | Indicates how often Tx New Space Available messages should |
| Request | be sent for this connection by the offload engine. The Tx Status |
| | can be sent once Y new bytes have been acknowledged. A |
| | timeout can also be used to ensure that acknowledged bytes are |
| | reported to the PE after at most X ms. A value of 0 means |
| | never. |
| Connection Status Request | This field contains one bit per possible TCP connection state |
| | and is used as a mask to request information about the TCP |
| | connection state. Every time the TCP connection state changes, |
| | if the bit associated with the new state is set to 1, a “TCP |
| | Connection Status” message will be sent from the offload |
| | engine. |

The Status Request properties of the connection can be changed at any time by sending a Change Status Request message.

Change Status Request (sent from PE 420 to offload engine 200)

| | |
|---|---|
| Offload engine | The offload engine connection identifier. Every |
| Connection ID | non-closed connection maintained by the offload |
| | engine has a different ID. |
| Rx New Data | See “Open TCP Connection” message description |
| Available | |
| Request | |
| Tx New Space | See “Open TCP Connection” message description |
| Available | |
| Request | |
| Connection | See “Open TCP Connection” message description |
| Status Request | |

Offload engine 200 will send a TCP Connection status to the PE whenever the TCP Connection State changes.

TCP Connection Status (sent from offload engine 200 to PE 420)

| | |
|---|---|
| Local | The local socket identifier |
| Connection | |
| ID | |
| Offload | The offload engine connection identifier. |
| engine | Every non-closed connection maintained by |
| Connection | the offload engine has a different ID. |
| ID | |
| Connection | This field indicates the current state of |
| Status | the connection (The possible states are |
| | CLOSED, LISTEN, SYN_RCVD, SYN_SENT, |
| | ESTABLISHED, FIN WAIT 1, FIN WAIT 2, |
| | CLOSE WAIT, CLOSING, TIME_WAIT) Note that |
| | CLOSED is an implicit state, and that |
| | once the connection is closed, it can no |
| | longer be accessed in any way. |
| Local IP | The IP address associated with the PE's |
| Address | socket. |
| Local Port | The port associated with the PE's socket |
| Number | |
| Foreign IP | The IP address associated with the foreign |
| Address | socket |
| Foreign | The port associated with the foreign socket |
| Port | |
| Address | |

PE 420 can close a connection by sending a “Close TCP Connection” message to the offload engine 200. This will start the closing process for the connection.

Close TCP Connection (sent from PE 420 to offload engine 200)

| | |
|---|---|
| offload engine | The offload engine connection identifier to be |
| Connection ID | closed. Every non-closed connection maintained |
| | by the offload engine has a different ID. |

PE 420 can also abort a connection which causes all pending send and receive operations to be aborted and a REST to be sent to the foreign host.

Abort TCP Connection (sent from PE 420 to offload engine 200)

| | |
|---|---|
| Offload engine | The offload engine connection identifier to be |
| Connection ID | aborted. Every non-closed connection maintained |
| | by the offload engine has a different ID. |

In the case of a serious error, such as multiple time-outs or a remote reset, a TCP Error message will be sent from the offload engine 200 to PE 420.

TCP Connection Status (sent from offload engine 200 to PE)

| | |
|---|---|
| Local Connection ID | The local socket identifier |
| Offload engine | Offload engine connection identifier. Every |
| Connection ID | non-closed connection maintained by Offload |
| | engine has a different ID. |
| Error Code | Description of Error |

### Transmitting Data

Once PE 420 has opened a connection and received the associated offload engine 200 Connection ID from offload engine 200, it can inform offload engine 200 that data is available to be sent using the “Tx New Data Available” message

Tx New Data Available (sent from PE 420 to offload engine 200)

| | |
|---|---|
| Offload engine | The offload engine 200 connection identifier |
| Connection ID | associated with the data to be sent |
| Tx Bytes Available | The number of bytes added to the Tx buffer since |
| | the last “Tx New Data Available” message was sent. |

Once the connection is established, offload engine 200 will read the available data from the associated Tx buffer 610 using several RapidIO™ READ commands, and send the data over the IP network 440 and wait for TCP acknowledgements from the remote host.

Once an acknowledgement is received, offload engine 200 will notify PE 420 that data has successfully been transmitted and that the space in the TX buffer can now be reused. This notification will be sent as requested by PE 420 using the Tx New Space Available Request field (either after a certain amount of data has been acknowledged or a certain amount of time has elapsed.)

Tx New Space Available (sent from
offload engine 200 to PE 420)

| | |
|---|---|
| Offload engine 200 | Offload engine 200 connection identifier |
| Connection ID | associated with the data to be sent |
| Tx Bytes Successfully | The number of bytes acknowledged by the |
| Transmitted | remote host since the last “Tx New Space |
| | Available” was sent |

### Receiving Data

When data is received from the remote host, offload engine 200 will write it into the PE 420's Rx Buffer 620 using several RapidIO™ WRITE commands. Offload engine 200 will notify PE 420 that new data is available. This notification will be sent as requested by PE 420 using the Rx New Data Available Request field.

Rx New Data Available (sent from offload engine 200 to PE 420)

| | |
|---|---|
| Offload engine 200 | Offload engine 200 connection identifier |
| Connection ID | associated with the data to be sent |
| Rx Bytes Available | The number of bytes written to the Rx buffer |
| | 620 by offload engine 200 since the last “Rx New |
| | Data Available” message was sent. |

Once PE 420 processes an amount of data (or moves it into an application buffer), the space can be freed for new data using the Rx New Space Available message.

Rx New Space Available (sent from
PE 420 to offload engine 200)

| | |
|---|---|
| Offload engine 200 | Offload engine 200 connection identifier |
| Connection ID | associated with the data to be sent |
| Rx Bytes Moved | The number of bytes acknowledged by the |
| | remote host since the last “Tx New |
| | Space Available” was sent |

### EXAMPLE

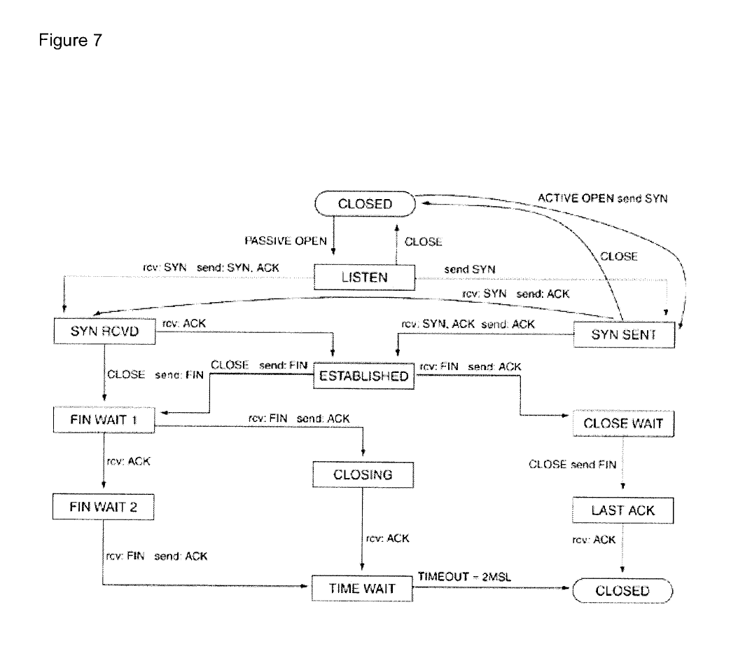

Throughout the following example (of a simple http server application), reference is made to TCP state chart shown in FIG. 7.

PE 420 begins by opening a passive connection with socket (tcp,192.168.1.4:80) and allocating 1 MB each for the Rx buffer 610 and Tx circular buffer 620 at addresses 0x100000 and 0x200000 respectively in its local memory.

PE sends “Open TCP Connection” to offload engine 200 with
Local Connection ID=5
Passive/Active=Passive
Local IP Address=192.168.1.4
Local Port=80
Foreign IP Address=0.0.0.0
Foreign Port=0
Rx Buffer Address=0x100000
Rx Buffer Size=1 MB
Rx New Data Available Request=After 10 ms or 4 kB
Tx Buffer Address=0x200000
Tx Buffer Size=1 MB
Tx New Space Available Request=After 0 ms (i.e. never) or 4 kB
Connection Status Request=All states

Offload engine 200 adds this connection to its tables in the LISTEN state.

Offload engine 200 sends “TCP Connection Status” message to PE 420:
Local Connection ID=5
Offload engine Connection ID=23
Connection Status=LISTEN
Local IP Address=192.168.1.4
Local Port Number=80
Foreign IP Address=0.0.0.0
Foreign Port Number=0

A remote host (192.168.5.2:4442) actively opens a connection to 192.168.1.4:80 and so the connection state changes to SYN_RCVD

Offload engine 200 sends “TCP Connection Status” message to PE 420:
Local Connection ID=5
Offload engine Connection ID=23
Connection Status=SYN_RCVD
Local IP Address=192.168.1.4
Local Port Number=80
Foreign IP Address=192.168.5.2
Foreign Port Number=4442

Soon afterwards, once the remote host has acknowledged offload engine 200's SYN, the connection state will change to ESTABLISHED, and offload engine 200 will start the Tx Status Timer and Rx Status Timer.

Offload engine 200 then sends “TCP Connection Status” message to PE 420:
Local Connection ID=5
Offload engine Connection ID=23
Connection Status=ESTABLISHED
Local IP Address=192.168.1.4
Local Port Number=80
Foreign IP Address=192.168.5.2
Foreign Port Number=4442

The remote host sends 772 bytes of TCP data, which offload engine 200 writes into PE 420's Rx buffer 620 as each packet it received. As offload engine 200 acknowledges packets, it reports the remaining size of Rx buffer 620 as the TCP window size. The Rx Buffer Status Timer is started as soon as the first packet is received.

When the Rx Buffer Status Timer reaches 10 ms, offload engine 200 sends “Rx New Data Available” message to PE 420:
Offload engine Connection ID=23
Rx Bytes Available=772

PE 420 reads the 772 bytes and processes the data. PE 420 then sends “Rx New Space Available” message to offload engine 200:
Offload engine Connection ID=23
Rx Bytes Moved=772

PE 420 writes 8,534 bytes TCP data into Tx Buffer 610 and then informs offload engine 200 of this new data by sending “Rx New Data Available” message to offload engine 200:
Offload engine Connection ID=23
Tx Bytes Available=8,534

Offload engine 200 reads this data and sends it to the remote host, segmenting it into MTU-sized IP packets and following the TCP sliding window/congestion control algorithm, keeping track of acknowledgements from the remote host.

After the 3rd acknowledgement, 4,344 bytes of data have been successfully acknowledged (which is greater than 4 kb).

Offload engine 200 then sends “Rx New Space Available” message to PE 420:
Offload engine Connection ID=23
Rx Bytes Available=4,344

After the 6^{th} acknowledgement, all 8,534 bytes have been successfully received at the remote host (a total of 4,190 bytes since the last Rx New Space Available message).

Offload engine 200 then sends “Rx New Space Available” message to PE 420:
Offload engine Connection ID=23
Rx Bytes Available=4,190

The remote host closes the connection, which is acknowledged by Offload engine 200, changing the TCP state to CLOSE_WAIT.

Offload engine 200 sends “TCP Connection Status” message to PE 420:
Local Connection ID=5
Offload engine Connection ID=23
Connection Status=CLOSE_WAIT
Local IP Address=192.168.1.4
Local Port Number=80
Foreign IP Address=192.168.5.2
Foreign Port Number=4442

PE 420 responds by closing its side of the connection.

PE 420 sends “Close TCP Connection” to Offload engine 200:
Offload engine Connection ID=23

Offload engine 200 sends the Close request to the remote host, and the TCP state is changed to LAST_ACK.

Offload engine 200 sends “TCP Connection Status” message to PE 420:
Local Connection ID=5
Offload engine 200 Connection ID=23
Connection Status=LAST_ACK
Local IP Address=192.168.1.4
Local Port Number=80
Foreign IP Address=192.168.5.2
Foreign Port Number=4442

PE 420 can now free the memory used for the Rx buffer 620 and Tx buffer 610.

The remote host acknowledges the close request, and the TCP connection is closed and removed from the offload engine 200 list of connections.

Offload engine 200 sends “TCP Connection Status” message to PE 420:
Local Connection ID=5
Offload engine Connection ID=23
Connection Status=CLOSED
Local IP Address=192.168.1.4
Local Port Number=80
Foreign IP Address=192.168.5.2
Foreign Port Number=4442

This completes the connection.

### Other Applications

The examples described above can be further enhanced by adding the following capabilities:

Encryption/Decryption—encryption and decryption steps may be added to the communications between processing elements 420 and offload engine 200 to maintain privacy.

Digital Signal Processing—sampling rate processes such as upsampling or downsampling may be used in the implementation of the system according to the invention.

Packet sniffing and filtering—the processing elements and/or offload engine 200 may employ protective mechanisms such as packet sniffers or packet filters.

Traffic Simulation/Generation—traffic generation models such as the 3GPP2 model and the 802.16 model may be implemented within the network.

Intelligent data distribution/Load balancing—to further increase efficiency, the network may employ load balancing and intelligent data distribution.

NAT—processing element and/or offload engine may employ network address translation (NAT) devices.

NFS, FTP, HTTP—the network according to the invention may employ HTTP, file transfer protocol (FTP) or network file system (NFS).

iWARP, RDMA—the network according to the invention may employ multiprocessing tools such as iWARP and RDMA.

While the invention above has been disclosed with reference to RapidIO™ switch fabric, other types of switch fabric could be used without detracting from the spirit of the invention. Although the particular preferred embodiments of the invention have been disclosed in detail for illustrative purposes, it will be recognized that variations or modifications of the disclosed apparatus lie within the scope of the present invention.

I claim:

1. A method of communicating a packet sent from a first processing element to a second processing element over a network, comprising the steps of:
a) a first processing element communicating a packet addressed to a second processing element;
b) said communicated packet, after leaving said first processing element, received by a switch fabric;
c) said communicated packet communicated from said switch fabric to an offload engine, said offload engine comprising a hardware application;
d) said offload engine acknowledging receipt of said communicated packet to said first processing element, and communicating said communicated packet to said processing element.

2. The method of claim 1, wherein said offload engine further comprises a timer, and wherein in step (d) said offload engine sets said timer; and further comprising:
e) if said offload engine fails to receive acknowledgement from said second processing element of receipt of said communicated packet prior to expiry of said timer, requesting said first processing element to resend said packet.

3. The method of claim 2 wherein, in step d), said offload engine further alters said packet so that said acknowledgement of receipt of said packet from said second processor will be addressed to said offload engine.

4. The method of claim 3 wherein said offload engine further comprises a NIC to receive and communicate said packet.

5. The method of claim 4 wherein said offload engine further comprises a state table to store the status of communications with said first processing element.

6. The method of claim 5 wherein said switched fabric is RapidIO.

7. The method of claim 6 wherein said offload engine is a field-programmable gate array.

8. The method of claim 7 wherein said packet is communicated from said first processing element via an ordered network.

9. The method of claim 8 wherein said packet is received by said second processing element via an unordered network.

10. The method of claim 7 wherein said packet is communicated from said first processing element via an unordered network.

11. The method of claim 10 wherein said packet is received by said second processing element via an ordered network.

12. The method of claim 7 wherein said network is an Ethernet network.

13. The method of claim 12 wherein said Ethernet network has a data traffic speed of at least 10 Gb/s.

14. A method of acknowledging receipt of a packet sent from a first processing element to a second processing element, comprising the steps of:
a) an offload engine comprising a hardware application, a state table and a timer, receiving said packet before said packet reaches said second processing element;
b) said offload engine modifying said packet so that acknowledgement of receipt of said packet will be sent from said second processing element to said offload engine;
c) acknowledging receipt of said packet to said first processing element;
c) said offload engine sending said packet to said second processing element, and starting a timer when said packet is send to said second processing element;
d) said offload engine, if not having received an acknowledgement from said second processing element that said packet has been received, requesting said first processing element resend said packet.

15. The method of claim 14 wherein said offload engine is in communication with a switched fabric.

16. The method of claim 14 wherein said offload engine is a field-programmable gate array.

17. A field programmable gate array for communicating packets from a first processing element to a second processing element, comprising:
a hardware application;
means for communication with a switched fabric;
means for communication with an Ethernet network;
a timer, and
a state table.

18. The field-programmable gate array of claim 16 further comprising:
means for providing acknowledgement to a first processing element of a packet received from said first processing element and addressed to a second processing element.

19. The field programmable gate array of claim 17 further comprising:
means for receiving acknowledgement of said packet from said second processing element.

20. The field programmable array of claim 19 further comprising means for timing the time taken for said acknowledgement from said second processing element be received.

21. The field programmable array of claim 20 wherein said state table translates an IP address to a RapidIO™ Device ID.
